(19) United States
(12) Patent Application Publication
(10) Pub. No.: US 2005/0264469 A1
(43) Pub. Date: Dec. 1, 2005

(54) Antenna coupler

(76) Inventor: Adam Nowotarski, Indianapolis, IN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/116,103

(22) Filed: Apr. 27, 2005

Related U.S. Application Data
(60) Provisional application No. 60/566,144, filed on Apr. 28, 2004.

(51) Int. Cl. H01Q 1/36

(52) U.S. Cl. 343/895

(57) ABSTRACT

What is described is an antenna coupler for testing wireless devices, said coupler comprising an accommodating element for holding the wireless device as well as, underlying said accommodating element, a dual-arm, planar spiral antenna for wireless communication with the wireless device.

This application claims priority to U.S. Provisional Application 60/566,144, filed Apr. 28, 2004, entitled “ANTENNA COUPLER,” which is incorporated herein by reference.

### BACKGROUND OF THE INVENTION

he invention relates to an antenna coupler for testing wireless devices, said coupler comprising an antenna element for wireless communication with the wireless device and an accommodating element for holding the wireless device.

Such antenna coupler is described, for example, in DE 19 732 639 C1. It is used for testing wireless devices, in particular mobile or cellular phones. Antenna couplers enable full final testing of a wireless device, because also the radio transmission properties of the wireless device, in particular its antenna function, can be checked. If, instead, a high-frequency interface, which is provided on many wireless devices, were resorted to for functional testing, the antenna would not be tested at all and antenna errors would not be detectable.

There are principally three different mechanisms for coupling with a wireless device. In inductive coupling, a coil is used as the coupling element, in whose center the antenna of the wireless device is introduced. The high-frequency field of the antenna of the wireless device then couples to the coil and can thus be evaluated for further test purposes. Although inductive coupling elements achieve a very high coupling factor, their mechanical realization is difficult. In particular, it is stringently required that the coil encloses the antenna of the wireless device. Therefore, in planar antennas used increasingly in wireless devices, inductive coupling can not be used at all or only to a very limited extent. However, inductive couplings are also confronted with concerns of measurement technology, because the small distance between the coupling coil and the wireless antenna may produce antenna detuning, including a change in the base point resistance of the wireless antenna, which then results in level distortions during measurement operation.

As an alternative to the inductive coupling, capacitive couplings are known, wherein a counter-surface is opposed to a planar wireless antenna such that both surfaces form a capacitor, by which high-frequency energy can be picked up from the wireless device. However, the coupling factors achieved thereby depend very strongly on the distance of the opposed surfaces; the coupling factor changes with the square of the distance. Therefore, high coupling factors require a very small distance between both surfaces. Moreover, apart from errors in measurement caused by variations in distance, capacitive coupling also entails the risk of influencing the function of the antenna of the wireless device such that the base point resistance is changed. Further problems of capacitive coupling arise due to reflections at the counter-surface, which may lead to interference in some wireless devices.

DE 19 732 639 C1 therefore proposes an antenna coupler wherein coupling is effected via an antenna element. Said element is arranged close to the antenna of the wireless device and functions neither in a capacitive nor in an inductive manner. The antenna element hardly leads to interfering influences and shows, in particular, a comparatively reduced sensitivity to changes in distance. However, it is indispensable for the antenna element to be tuned to the frequency of the wireless device, as a result of which the frequency range covered by known antenna elements is smaller than the range in which the various mobile phone systems operate. The antenna coupler described in DE 19 732 639 C1, therefore, comprises two independent spatially separated planar antennas. A dipole antenna is provided for a frequency range of from 1.7 to 2.0 GHz and a slot antenna is provided for a frequency range around 0.9 GHz, in order to enable testing of mobile phones for all common networks. The spatial separation of the planar antennas leads to certain requirements in connection with the alignment of the mobile phone, to ensure that the mobile phone antenna is located at approximately the same distance from each of the two planar antennas.

A concept is known from DE 101 29 408 A1, which suggests one single antenna for all frequency ranges to be covered. Said antenna is provided as a closed loop, which is composed of an internal conductor and an external conductor. The loop is fixed above a reflector plane by several holders made of teflon. The position in height of the loop above the reflector plane is essential for the operating frequency of the antenna, and thus has to be adjusted as exactly as possible. The concept according to DE 101 29 408 A1 thus leads to a relatively complex antenna structure as compared to the known planar antenna.

### SUMMARY OF THE INVENTION

Therefore, it is an object of the invention to provide an antenna coupler which allows to reduce the requirement with respect to the alignment of the mobile phone and at the same time enables a simpler antenna design.

This object is achieved by an antenna coupler for testing a wireless device, said coupler comprising an accommodating element for holding the wireless device and, a planar spiral antenna for wireless communication with the wireless device, which antenna lies below said accommodating element.

Owing to the spiral antenna the antenna coupler according to the invention covers a frequency range from 0.5 to 3.0 GHz with one single antenna, which is, in addition, easy to manufacture from circuit-board material. Such broadband capacity has hitherto required complex antenna concepts in the prior art. Thus, the antenna coupler according to the invention combines the advantages of the solutions known from the prior art while avoiding their disadvantages. Although already known since the 1950s, spiral antennas have so far not been used for wireless communication with wireless devices in antenna couplers, which may also be due to the fact that they have been described for application at considerably higher frequencies. Thus, for example, the publication by Wang J., “Design of Multioctave Spiral-Mode Microstrip Antennas”, IEEE Transactions on Antennas and Propagation, Vol. 39, No. 3, page 332, 1991, mentions frequencies in the range around 10 GHz. This is far beyond wireless transmission frequencies. Further, spiral antennas usually generate a circularly polarized field. Surprisingly, however, as the inventor has found, this has no disadvantages whatsoever for wireless transmission applications.

A spiral antenna may be principally provided as a spiral having one arm or as a spiral having several arms. In a dual-arm spiral, two conductor strips may be placed next to each other in the form of an intertwined double spiral. It has turned out that an antenna coupler comprising such dual-arm spiral antenna achieves particularly good coupling factors to the wireless device to be tested. The spiral antenna is preferably formed by two conductor strips wound in the form of a double spiral, said conductor strips having an offset of 180° therebetween, with reference to the origin.

The spiral of the planar antenna may be realized in different ways, thus enabling adjustment to given geometric conditions. Accordingly, it may be provided as a square or round Archimedian spiral or as a logarithmic spiral. Depending on the housing and on tuning, one of these variants may achieve optimal coupling factors.

A planar spiral antenna emits electric power in both directions perpendicular to the plane. Since the wireless device is located at the antenna coupler only on one side of the plane, it is advantageous to mount the spiral antenna, with reference to the position of the wireless device, above a shielding plane, in order to absorb or reflect radiation power, which the spiral antenna emits away from the wireless device.

Both the spiral antenna and the shielding plane can be formed by circuit boards. In doing so, it is possible to use multi-layer circuit board systems. It has turned out that the distance between the surface of the spiral antenna and the shielding plane should be smaller than or equal to a quarter-wavelength of the radiation to be transmitted, because otherwise the emission properties may be considerably impaired. In a preferable embodiment of the invention, values of around 2.3 cm are realized, which excludes conventional multi-layer printed circuit boards for manufacturing the spiral antennas and the shielding plane. It is therefore preferred to either use a special printed circuit board with spacing between two conductor planes that is in the centimeter range or to form the spiral antenna and the shielding plane from independent, spaced apart circuit boards.

If the spiral antenna of the antenna coupler according to the invention has a dual-arm design, it comprises a symmetric input. However, most measurement systems in which the antenna coupler is to be applied, use non-symmetric coaxial wiring. Therefore, a further embodiment of the antenna coupling is advantageous which embodiment comprises a connecting system for the spiral antenna, said system guiding a coaxial input onto both arms of the spiral antenna such that one arm of the spiral antenna is connected with the coaxial center contact and the other arm is connected with the coaxial shield contact.

In a convenient embodiment a transducer is used for the connecting system, which is also referred to as “balun” and suitably transduces the parallel input of the spiral antenna into a coaxial input. Such transducers are principally known in the prior art. Under the aspect of a space-saving and well-shielded structure, they often present problems. In an arrangement, which has a surprisingly compact structure and is at the same time well-shielded, the transducer is placed, according to a further embodiment of the invention, between the spiral antenna and the shield or an additional shield and connects both arms of the spiral antenna to the center contact of the coaxial input and the shield, respectively with the shield being, then connected to the coaxial shield contact. The shield may be provided as a shielding plane located below the spiral antenna.

The broadband properties of the spiral antenna remain fully unchanged, if the transducer is connected to the center contact of the coaxial input by means of a conductor strip, which conductor strip comprises at least one tuning element for frequency tuning. This tuning elements may be realized, for example, in the form of one or more shielding studs attached to the conductor strip and/or by suitable variation of the width of the conductor strip.

Particularly good shielding is achieved by using a two-layer shielding system, which may be realized, for example, in form of a two-layer printed circuit board located below the spiral antenna with reference to the accommodating element for the wireless device. That shielding than comprises, relative to the accommodating element, are first upper as well as a lower second layer shielding plane. If the transducer is arranged below the spiral antenna centrally, it is, in the aforementioned arrangement between the spiral antenna and the shield, optimally protected from interfering influences. Possible interference could then only originate from the line which connects the transducer to the center contact of the coaxial input. This interference is maximally suppressed if the shield is provided in a two-layer form and a shielding plane is located between the conductor connecting the transducer to the center contact of the coaxial input. In this embodiment, the transducer is thus located between stack of printed circuit board, on whose uppermost printed circuit board the spiral antenna is formed an whose lower-most two-layer printed circuit board performs shielding functions and establishes a contact with the transducer from the coaxial side.

By mounting this stack of printed circuit boards in a shielding housing whose top surface is formed by the printed circuit board comprising the planar spiral antenna, an encapsulated antenna coupler which emit little interfering radiation is obtained.

In some cases, the connecting system may lead to an anisotropy of the field emitted by the spiral antenna. This anisotropy has the effect that the main axis on which the maximum intensity of emission is achieved no longer extends perpendicular to the antenna surface, but is tilted out of normal. If the conductor strips of the connecting system are arranged so as to extend away from the wireless device (i.e., away from the accommodating element), this anisotropy will cause tilting of the main axis towards the wireless device and is then considerably less detrimental. Therefore, a embodiment is preferred, wherein the accommodating element is arranged in at least one resting position in one half of the antenna coupler and the conductive path structure of the connecting system is located in the other half of the antenna coupler and extends away from the accommodating element.

### DESCRIPTION OF THE FIGURES

The invention will be described in more detail below, by way of example, with reference to the figures, wherein:

FIG. 1 shows a perspective representation of an antenna coupler;

FIG. 2 shows a sectional representation of the antenna coupler of FIG. 1;

FIG. 3 shows a top view of an antenna circuit board of the antenna coupler according to FIG. 1;

FIG. 4 shows a top view of a first upper shielding plane of a ground printed circuit board of the antenna coupler according to FIG. 1 and

FIG. 5 shows a top view of a second lower shielding plane of the ground printed circuit board.

### DETAILED DESCRIPTION

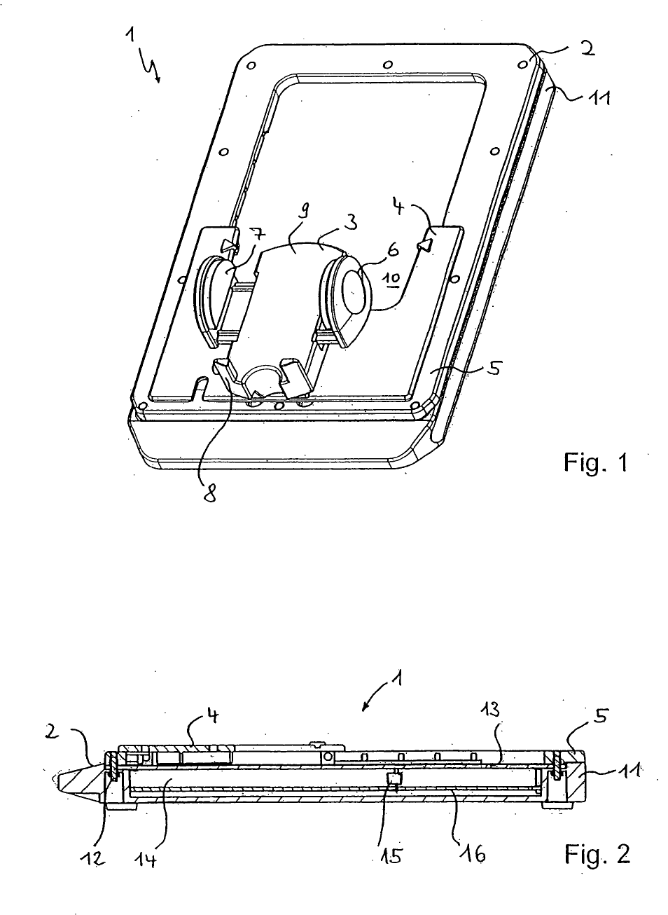

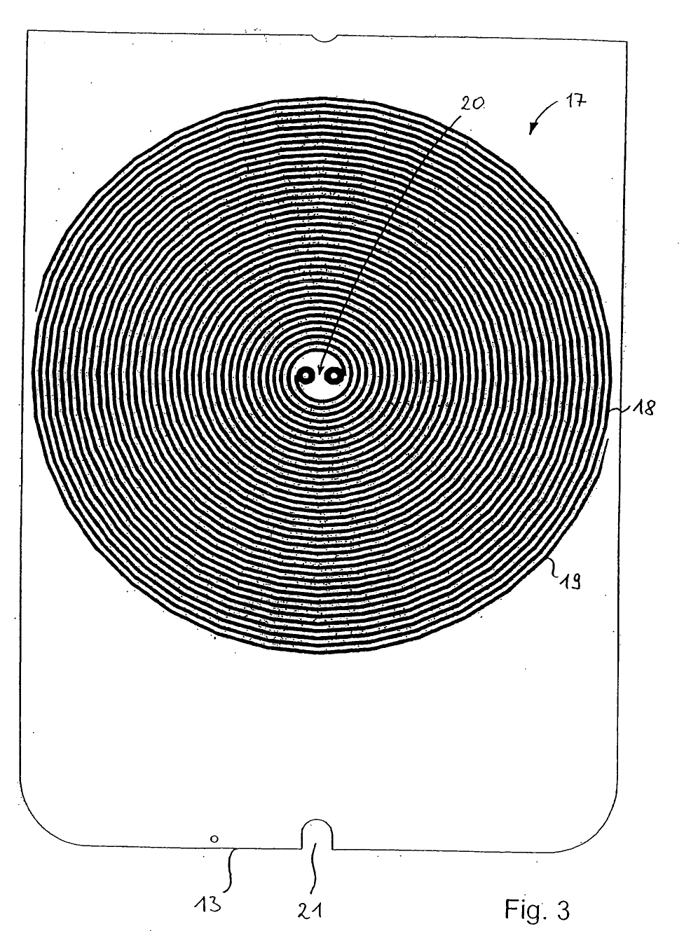

FIG. 1 shows a perspective view of an antenna coupler 1, which serves to integrate a wireless device (e. g. a mobile phone all the like, not shown here) into a measuring system in a wireless manner. The antenna coupler 1, which is also shown in a sectional representation in FIG. 2, establishes a wireless communication with the wireless device and is in turn connected with a measuring unit by wiring (not shown).

The antenna coupler 1 comprises a housing 2 on which a support 3 is formed, which is, in the shown embodiment example, realized as a universal holder for wireless devices. That holder may accommodate mobile phones of almost any construction and also PDA mobile phone combination devices. The holder 3 is mounted on a slide 4, which is displaceably guided on a frame 5 forming the top surface of the housing 2.

For measurements, the wireless device is inserted into the holder 3 and, in the construction shown in FIG. 1, is fixed by clamping jaws 6, 7 of the holder 3. Wireless communication is effected between the antenna of the wireless device and an antenna which is mounted in the housing 2 below the frame 5. In the presently described embodiment, the antenna of the antenna coupler is provided as a planar antenna in strip-conductor technology.

The wireless device abuts against a stop 8 on the button surface of the holder, so it is securely held on a supporting surface 9 by the clamping jaws 6, 7 and the stop 8. Depending on its construction, the wireless device protrudes more all less over the holder 3. In most wireless devices, the antenna is located in this protruding region.

In order to avoid interferences in wireless communication, the slide 4 comprises a recess 10, so that no or as little possible interfering material as possible is placed between the antenna of a wireless devices protruding over the holder 3 and the planar antenna of the antenna coupler 1.

The slide 4 is displaceable along the longitudinal axis of the antenna coupler 1 and comprises a locking mechanism, which together with groves formed on the frame 5 allows to lock the slide 4 in different positions. A pointer mounted on the slide 4 allows for easy recognize of the position of the slide 4, if marks (which will be describe later) are placed above the planar antenna. A wireless device placed on the supporting surface 9 of the holder 3 and fixed by means of the clamping jaws 6 und 7 can thus be put in an optimum position relative to the planar antenna. A button is provided on the holder 3 in order to release the clamping jaws 6 and 7, that button releasing a fixation mechanism which is provided in the holder 3 and which locks the clamping jaws 6 and 7.

As the sectional representation of FIG. 2 clearly shows, the housing 2 is composed of a button part 11 and the frame 5 is mounted thereon. The frame 5 is fixed to the button part 11 via pins 12 and thus secures an antenna circuit board 13 in an interior 14 of the housing, on which circuit board the planar antenna is provided. In the interior 14 of the housing antenna feed line leads to the antenna circuit board 13 via a transducer 15 being connected between the antenna circuit board 13 and a ground printed circuit board 16 on which a coaxial input is provided.

A dual-arm spiral antenna, which will be explained in more detail herein after with reference to FIG. 3, is formed on the surface of the antenna circuit board 13 which surface is the button surface of the board 13 with respect to the position of the wireless device, i.e. the antenna is formed on that surface of the antenna circuit board 13 which is located towards the interior 14 of the housing. The terminals of both arms of the spiral antenna are connected by the transducer 15 to the button surface of the ground printed circuit board 16, which is located below the antenna circuit board 13. The transducer 15 transforms the two terminals of the spiral antenna, which, as will be explained below, are located besides each other, into a coaxial input. Thus, the transducer 15 is connected with the antenna circuit board 13 its the input side and with a shield contact as well as a center contact of the coaxial input on its output side. In one embodiment, the transducer 15 is model ETC 1.6-4-2-3 of AMP Incorporated, USA, distributed under the trade name M/A-COM.

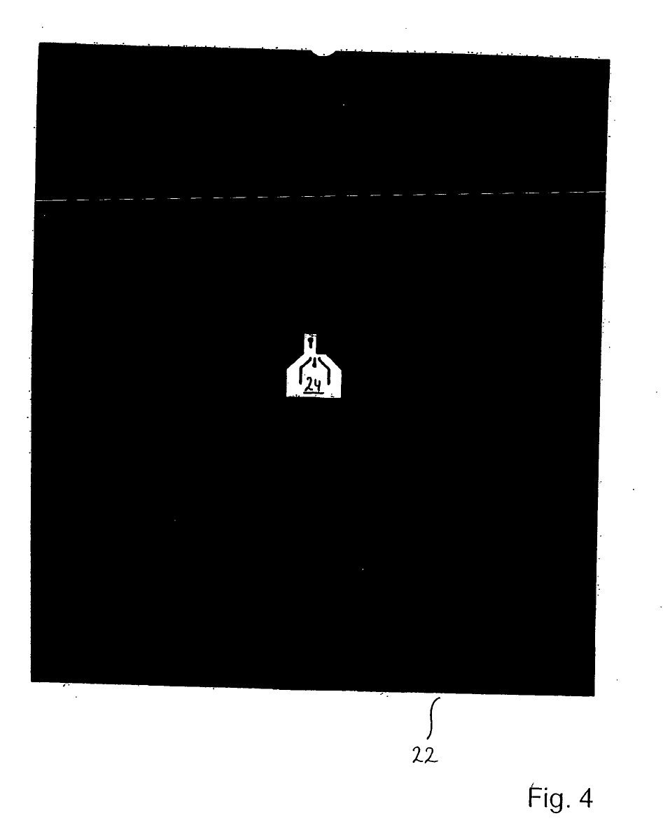

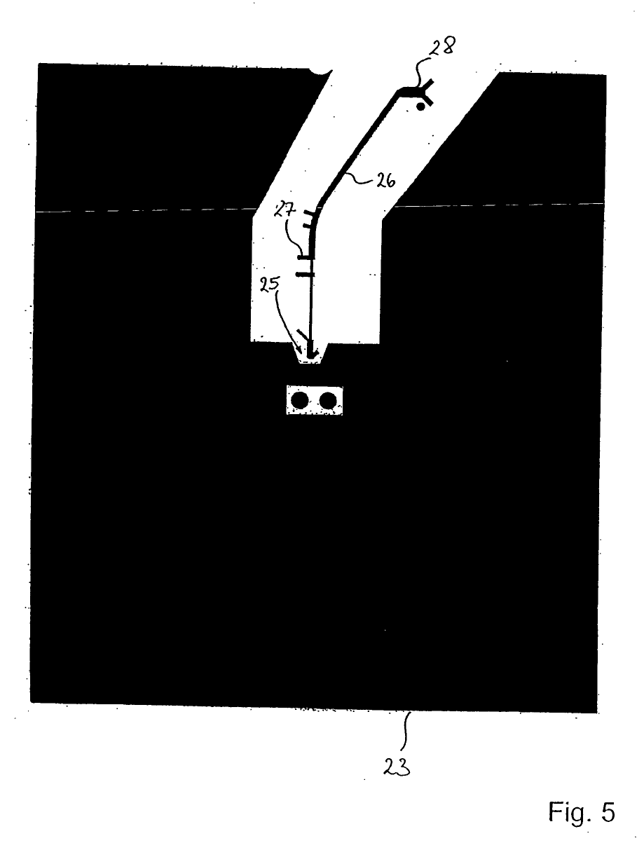

A shielding face, which is structured suitably for the transducer 15 and otherwise serves as ground plane, is provided on the top surface of the ground printed circuit board 16, i.e. on the board's 16 side facing the antenna circuit board 13. The button surface of the ground printed circuit board 16 is also provided with a shielding structure as well as with a corresponding feed conductor, which connects the transducer 15 to the center contact of the coaxial connection. This will be described later with reference to FIGS. 4 and 5.

The antenna circuit board 13 forms the top surface of the housing 2 within the frame 5 and is located such that its spiral antenna structure faces downward in the housing (relative to the slide 4). This protects the conductor structure of the spiral antenna against damage. The printed ground circuit board 16 shields the spiral antenna from below and, at the same time, serves as a reflector. The spacing between the printed ground circuit board and the spiral antenna is approximately 2.3 cm in this embodiment. It is usually not greater than a quarter of the wavelength of the upper limit of the desired frequency band, in which the antenna coupler shall being used. The spacing must never be equal to half a wavelength, because the reflector causes an amplification according to the function sin (2αA/λ), wherein A is the spacing between the surface of the spiral antenna and the shielding plane and λ is the wavelength of the emitted radiation. The button part 11 shields the interior of the housing and the periphery of the antenna.

The antenna circuit board 13 is shown in a top view onto the conductor structure in FIG. 3. As can be seen, the conductive path is structured in form of a spiral antenna 17, which is composed of two Archimedian spiral arms 18, 19. The spiral arms 18 and 19 have an offset of the 180° between them, relative to an antenna base point 20, which is the center of the spiral.

The circular Archimedian spiral used in the embodiment example of FIG. 3 generally satisfies the equation r=a·φ (r: radial coordinate, Φ: angle coordinate, a: growth parameter) in polar coordinates. Four functions describe the conductive path boundaries of the two arms for the dual-arm Archimedian spiral antenna 17 of FIG. 3. These functions all satisfy the form r=a·φ+b. The four graphs for the boundary surfaces of the conductor strips differ merely with respect to the parameter b. Values b1 and b2 define the first spiral arm 18, and the difference |b1-b2| defines the width of the first spiral arm 18. The same applies for corresponding values b3 and b4. In the embodiment of FIG. 17, the parameters are selected such that the spiral arms 18 and 19 have equal width and the spacing between the spiral arms 18 and 19 is a little larger than the conductor strip width. For the conductor strip width B and the growth parameter a the equation a=2B/φ hold for the spiral antenna 17. The conductor area fraction of the spiral antenna 17 has an effect on the impedance of the antenna. The ratio of the spiral arm width and the spacing of the spiral arms allows adjustment of the area fraction of the conductor strips relative to the total surface area.

Instead of the round Archimedian spiral of FIG. 3, a square or rectangular spiral is also possible as an alternative, which corresponds to the spiral antenna of FIG. 3 in square or rectangular shape. A hyperbolic or logarithmic spiral may also to be used. In this connection, reference is made to the publication by Bronstein I., Semendjajew K., “Taschenbuch der Mathematik”, 22nd edition, Verlag Harri Deutsch, Thun, 1985, Germany, pages 94 et seq.

The transducer 15, which connects the two spiral arms 18 and 19 to the coaxial shield terminal, i.e. the printed ground circuit board 16, and also to the coaxial center terminal via a conductive path structure, is arranged below the base point or center 20 of the spiral antenna 17 in FIG. 2.

FIG. 4 shows the shielding plane on the top surface 22 of the printed ground circuit board 16. FIG. 5 illustrate the second shielding plane comprising the afore-mentioned conductive path structure, which plane is arranged on the button surface 23 of the printed ground circuit board 16. On the top surface 22 of the printed ground circuit board 16. Transducer contacts 24 are formed which connect, one output terminal of the transducer 15 to the coaxial shield terminal, i.e. the metallized top surface 22 of the printed ground circuit board 16.

In addition to an shielding structure a conductive path structure is also formed on the button surface 23 of the printed ground circuit bard 16, that structure connecting via a conductor strip 26 a center terminal 25 of the transducer 15 with a center contact 28 of the coaxial input terminal. The coaxial input terminal (not shown in FIG. 5) is mounted on the printed ground circuit board 16 and has its shielding connected to both ground planes, i.e. with the metallizations on the top surface 22 and on the button surface 23 of the ground printed circuit board 16.

In order for the conductor strip 26 not to impair the broadband characteristic of the spiral antenna 17 by its frequency behavior and in order for it to ideally compensate for inhomogeneity of frequency caused by the transducer 15, the conductor strip 26 has an varying width, according to one embodiment, over its length and is provided with tuning studs 27 which are located transversely or obliquely to the longitudinal extension of conductor strip 26.

In an area around the connecting system comprising the conductor strip 26, there is no further conductor material on the button surface 23 of the ground printed circuit board 16. The remaining conductor material of the printed ground circuit board 16 forms a further ground plane on the button surface 23, which plane is also connected with the zero potential. This further improves shielding.

Depending on the shielding requirements, the structure shown in FIG. 5 may also be the only grounding plane and the additional plane of FIG. 4 may be dispensed with. Of course, a further shielding plane may be provided below the plane of the conductor strip 26 as an alternative or as a supplement.

In order to allow precise allocation of the position of the holder 3 on the slide 4 relative to the housing 2 with the spiral antenna 17, a front foil may be adhered to the antenna circuit board 13, which foil may comprise, in addition to an index mark extending along the longitudinal inner edge of the frame 5, a central mark (e. g. of concentric closed curve). The center is the base point 20 of the spiral antenna 17. The index mark allows a user to position the slide 4 in a reproducible manner. As a result, it is possible to provide maintenance instructions for a certain type of wireless device with the corresponding index indication, so that wireless devices of this type are always tested in the same mutual orientation of the antenna of the wireless device and the spiral antenna 17. If no such instructions are to be made or if they are not available, a user may himself find the optimal orientation of the wireless antenna relative to the spiral antenna 17 with the help of the center mark.

1. An antenna coupler for testing a wireless device, said coupler comprising an accommodating element for holding the wireless device and a planar spiral antenna for wireless communication with the wireless device, which planar spiral antenna is located below the accommodating element.

2. The antenna coupler as claimed in claim 1, wherein the spiral antenna is of a dual-arm type.

3. The antenna coupler as claimed in claim 2, wherein the spiral antenna is formed by two conductor strips extending in the form of a double spiral.

4. The antenna coupler as claimed in claim 1, wherein the spiral antenna is provided as a square or round Archimedian spiral or as a logarithmic or hyperbolic spiral.

5. The antenna coupler as claimed in claim 1, wherein the spiral antenna is mounted, relative to the accommodating element, above a shield.

6. The antenna coupler as claimed in claim 5, wherein the spiral antenna and the shield are formed by circuit boards.

7. The antenna coupler as claimed in claim 2, comprising a connecting system, which is provided below the spiral antenna, relative to the accommodating element, and which connects a coaxial input to two arms of the spiral antenna.

8. The antenna coupler as claimed in claim 6, wherein the spiral antenna is of a dual-arm type and wherein the connecting system comprises a converter, which is arranged between the spiral antenna and the shield and which is connected, on the one hand, to the two arms of the spiral antenna and, on the other hand, to the central contact of a coaxial input and the shield.

9. The antenna coupler as claimed in claim 8, wherein the converter is connected to the central contact by a conductor strip, said conductor strip comprising at least one tuning element for frequency tuning.

10. The antenna coupler as claimed in claim 9, whose shield is of a two-layer type and comprises, relative to the accommodating element, an upper first and a lower second shielding plane, with the conductor strip being arranged in the lower second shielding plane and the converter being in contact with both shielding planes.

11. The antenna coupler as claimed in claim 9, wherein the accommodating element for holding the wireless device is located in a lower half of the antenna coupler and the conductor strip extends from the accommodating element in an upper half of the antenna coupler.

12. The antenna coupler as claimed in claim 10, wherein the accommodating element for holding the wireless device is located in a lower half of the antenna coupler and the conductor strip extends from the accommodating element in an upper half of the antenna coupler.
